(19) United States
(12) Patent Application Publication
(10) Pub. No.: US 2011/0155850 A1
(43) Pub. Date: Jun. 30, 2011

(54) CROSS-BEAM AND AN AIRCRAFT WITH CROSS-BEAMS OF THIS TYPE

(75) Inventor: Torsten Noebel, Neuendeich (DE)

(73) Assignee: AIRBUS OPERATIONS GMBH, Hamburg (DE)

(21) Appl. No.: 12/980,412

(22) Filed: Dec. 29, 2010

Related U.S. Application Data
(60) Provisional application No. 61/290,510, filed on Dec. 29, 2009.

(30) Foreign Application Priority Data
Dec. 29, 2009 (DE) 10 2009 060 694.7

(51) Int. Cl. B64C 1/18; B64C 1/06

(52) U.S. Cl. 244/119

(57) ABSTRACT

A cross-beam for a floor structure of an aircraft includes a web having opposing end sections configured to connect to opposing structural sections of an aircraft fuselage and at least one stepped section. The stepped section is formed by a displacement of the web in a direction corresponding to a normal axis of the web.

### CROSS REFERENCE TO RELATED APPLICATIONS

This application claims priority from U.S. Provisional Patent Application No. 61/290,510, filed Dec. 29, 2009 and German Patent Application No. 10 2009 060 694.7, filed Dec. 29, 2009, which are each hereby incorporated by reference herein in their entirety.

### FIELD

The invention relates to a cross-beam for a floor structure of an aircraft, and an aircraft with cross-beams of this type.

### BACKGROUND

Conventional passenger aircraft, in particular wide-bodied aircraft, mostly have a floor structure 1 as shown in FIG. 1, which essentially consists of cross-beams 2, support struts 4a, 4b, seating rails 6a, 6b, 8a, 8b, support rails 10 (position indicated by the dot-dash line), a floor 12, and a surface structure 14. For purposes of increasing the bending strength of the cross-beams 2 the latter are normally supported by means of the support struts 4a, 4b on a lower section of the respective frame. The floor 12 is supported above the cross-beams 2 on the seating rails 6, 8 and on the support rails 10a, 10b arranged between the inner seating rails 6b, 8b. The surface structure 14 is arranged underneath the cross-beam 2 and bounds an installation space 16 underneath the cross-beam 2 for the laying of systems cabling 18a, 18b. Moreover, it forms a ceiling of a lower aircraft space, for example a freight loading space. To maximise the volume of the freight loading space it is advantageous if the surface structure 14 is positioned as close as possible to the cross-beam 2. In order nevertheless to be able to arrange the systems cabling 18a, 18b in the installation space 16, the cross-beam 2 has in a lesser loaded section a lower flange 20 that is stepped-back to accommodate the systems cabling 18a, 18b. What is disadvantageous in this solution is, however, that the installation space 16 is only suitable for accommodating systems cabling 18a, 18b with relatively small cross sections.

Compare for this purpose also DE 31 41 869 A1, which shows a floor structure with cross-beams, which have a constant cross-section and are provided in each case with a multiplicity of holes, which are fundamentally suitable for the accommodation of systems cabling. The threading of the systems cabling is very labour-intensive, however, and also can easily lead to damage of the systems cabling.

### SUMMARY

An aspect of the present invention is to create a cross-beam that avoids the disadvantages cited above and has an enlarged installation space for a system installation, and an aircraft with cross-beams of this type.

In an embodiment, the present invention provides a cross-beam for a floor structure of an aircraft including a web having opposing end sections configured to connect to opposing structural sections of an aircraft fuselage and at least one stepped section. The stepped section is formed by a displacement of the web in a direction corresponding to a normal axis of the web.

### BRIEF DESCRIPTION OF THE DRAWINGS

An exemplary embodiment of the present invention is described in more detail below with reference to the schematic drawings, in which:

FIG. 1 shows a conventional aircraft floor structure; and

FIG. 2 shows an embodiment of a floor structure in accordance with the invention.

In the figures the same design elements bear the same reference numbers, wherein where there is a plurality of the same design elements in one figure just some of these elements are provided with a reference number for reasons of clarity.

### DETAILED DESCRIPTION

A cross-beam in accordance with an embodiment of the invention for a floor structure of an aircraft has a web, which can be connected via its end sections that are facing away from one another to opposing structural sections of an aircraft fuselage. The web can have at least one stepped section, which is formed by a displacement of the web in the direction of its normal axis. The displacement causes a recess to be formed, which results in an enlargement of the installation space. There is no need to worry about any structural weakening of the cross-beam, since the web is not only displaced “upwards” on its lower flange side, but on its upper flange side also. In this manner, systems cabling with increased cross sections can be accommodated, with an unaltered, or nearly unaltered, installation location of a surface structure to bound the installation space underneath the cross-beam. The additional volume gained in terms of the height of the installation space leads to a simplified system installation and can lead to reduced fuselage diameters.

In one embodiment the stepped section is designed in the centre of the cross-beam, so that the systems cabling with the increased cross sections can conveniently be arranged in the region of the longitudinal axis of the aircraft. Here in a further development an upper flange section of the stepped section can be embodied as a support surface of a floor. This has the advantage that conventional support rails are eliminated, resulting in simplified and faster installation. Also by this means a weight reduction is achieved.

The cross-beam is preferably dimensioned with reference to the loading. That is to say, in highly loaded sections it has a greater cross-section than in lesser loaded sections. Thus one embodiment envisages designing the stepped section and its adjacent web sections with the same cross-section. Another embodiment envisages embodying the stepped section with a reduced cross-section compared with adjacent web sections. In addition the web sections can have in each case a lower flange section that is set-back compared with the end sections. Here the cross-beam can be embodied with particularly small cross sections if the fuselage has a circular, or a near-circular, cross-section, since in such cases only relatively small tensile loads act on the cross-beam.

An aircraft in accordance with an embodiment of the invention has a fuselage in which a multiplicity of cross-beams is positioned to accommodate a floor. The cross-beams have in each case a web, which is connected via its end sections that are facing away from one another to opposing structural sections of the aircraft fuselage. In accordance with the invention the web has at least one stepped section, which is formed by a displacement of the web in the direction of the aircraft's normal axis. By this means additional installation space is created underneath the cross-beam for systems cabling, for example, leading to a simplified system architecture and/or to reduced fuselage diameters.

In one embodiment the systems cabling with large cross sections is arranged underneath the at least one stepped section, and the systems cabling with small cross-sections is arranged in web sections on both sides of the stepped section.

In accordance with the side view in FIG. 2 a preferred floor structure 22 has a cross-beam 24 with a web 26, which with its end sections 28, 30, is rigidly connected to lateral frame sections, not represented, by means of rivets, for example, and is stabilised by means of an upper flange 32 and a lower flange 34. For purposes of increasing the bending resistance it is supported in the region of its end sections 28, 30 via two vertical support struts 4a, 4b on lower frame sections.

In its central section the cross-beam 24 has a stepped section 36, which is formed by a displacement of the upper flange 32 and the lower flange 34 in the z-direction, i.e. “upwards” in the direction of its normal axis. The stepped section 36 and its adjacent sections 38, 40 have a constant and uniform cross-section in the embodiment shown. The web sections 38, 40 have in each case a lower flange section 42, 44, that is stepped-back relative to the end sections 28, 30, and are designed with reduced cross-sections compared with the end sections 28, 30. In this manner the cross-beam 24 is optimally dimensioned with reference to loads, and has a two-times stepped-back lower flange 34. Here the central step-back in the region of the stepped section 36 is formed by means of an S-bend in the upper and lower flanges 32, 34, and the lateral steps-back in the region of the web sections 38, 40 are formed by a setting-back of the lower flange sections 42, 44.

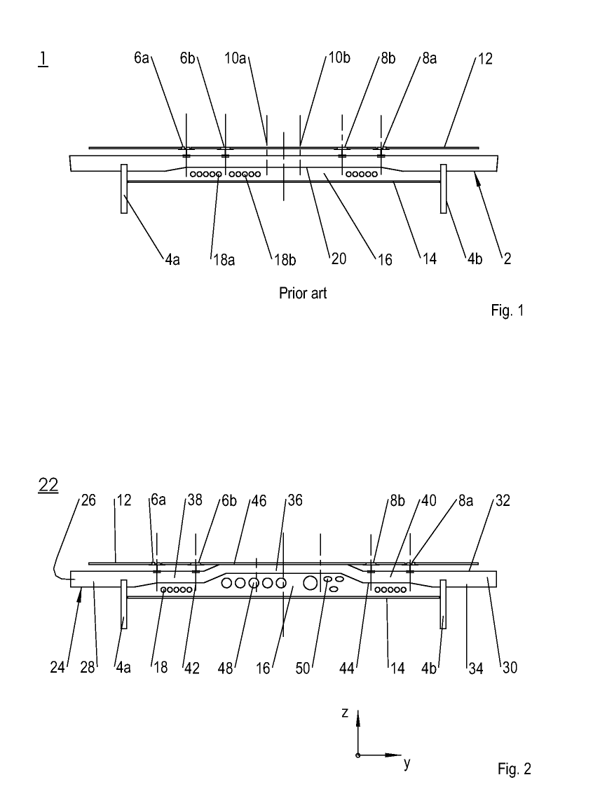

On the upper flange side the cross-beam 24 has seating rails 6a, 6b, 8a, 8b for the accommodation of rows of passenger seating, and for the support of a floor 12. Here the stepped section 36 has a height such that its upper flange section 46 serves as a support surface for the floor 12, and the latter can be laid down flat upon it. The use of conventional support rails (cf. FIG. 1, 10a, 10b) between the inner seating rails 6b, 8b is thus dispensed with.

On the lower flange side the cross-beam 24 has a surface structure 14, which bounds an installation space 16 for purposes of systems installation, for example for the accommodation of systems cabling 18, 20. By virtue of the two-times stepped-back lower flange 34 in the region of the stepped section 36 the installation space 16 in the region of the stepped section 36 has a greater height than in the region of the one-time stepped-back lower flange sections 42, 44. By this means systems cabling 48 with large cross-sections can conveniently be arranged underneath the stepped section 36, and systems cabling 18 with small cross-sections can be arranged underneath the web sections 38, 40, without the need for an installation location of the surface structure 30 to be fundamentally altered compared with floor structures of known art (cf. FIG. 1, 1). Also bundles of cables 50 consisting of a multiplicity of systems cabling 18 with small cross-sections can be arranged in the region of the stepped section 36.

Disclosed is a cross-beam 24 for a floor structure of an aircraft, which has at least one stepped section 36 formed by a section-by-section displacement of its web 26 in the direction of its normal axis z; also disclosed is an aircraft with a multiplicity of cross-beams 24 of this type.

While the invention has been particularly shown and described with reference to preferred embodiments thereof, it will be understood by those skilled in the art that various changes in form and details may be made therein without departing from the spirit and scope of the invention.

### REFERENCE SYMBOL LIST

1 Floor structure
2 Cross-beam
4 Support strut
6 Seating rail
8 Seating rail
10 Support rail
12 Floor
14 Surface structure
16 Installation space
18 Systems cable
20 Lower flange
22 Floor structure
24 Cross-beam
26 Stepped section
28 End section
30 End section
32 Upper flange
34 Lower flange
36 Stepped section
38 Web section
40 Web section
42 Lower flange section
44 Lower flange section
46 Upper flange section
48 Systems cable
50 Cable bundle

What is claimed is:

1: A cross-beam for a floor structure of an aircraft, the cross-beam including a web comprising:
opposing end sections configured to connect to opposing structural sections of an aircraft fuselage; and
at least one stepped section formed by a displacement of the web in a direction corresponding to a normal axis of the web.

2: The cross beam recited in claim 1, wherein the at least one stepped section is disposed in a center of the web.

3: The cross beam recited in claim 2, wherein the stepped section includes an upper flange section configured to provide a support surface for a floor.

4: The cross beam as recited in claim 2, wherein cross-sections of the web are optimized with respect to loading.

5: The cross beam as recited in claim 3, wherein cross-sections of the web are optimized with respect to loading.

6: The cross-beam recited in claim 1, wherein the at least one stepped section has a same cross-section as first and second web sections adjacent to the at least one stepped section.

7: The cross-beam recited in claim 4, wherein the at least one stepped section has a same cross-section as first and second web sections adjacent to the at least one stepped section.

8: The cross-beam recited in claim 1, wherein the at least one stepped section has a smaller cross section than first and second web sections adjacent to the at least one stepped section.

9: The cross-beam recited in claim 4, wherein the at least one stepped section has a smaller cross section than first and second web sections adjacent to the at least one stepped section.

10: The cross beam as recited in claim 6, wherein each of the first and second web sections have a lower flange section that is stepped back relative to a lower flange section of an end section of the web.

11: The cross beam as recited in claim 7, wherein each of the first and second web sections have a lower flange section that is stepped back relative to a lower flange section of an end section of the web.

12: The cross beam as recited in claim 8, wherein each of the first and second web sections have a lower flange section that is stepped back relative to a lower flange section of an end section of the web.

13: The cross beam as recited in claim 9, wherein each of the first and second web sections have a lower flange section that is stepped back relative to a lower flange section of an end section of the web.

14: An aircraft comprising:
a fuselage including opposing structural sections;
a floor;
a plurality of cross-beams positioned so as to accommodate the floor, each cross-beam having a web including
opposing end sections connected to the opposing structural sections of the fuselage; and
at least one stepped section formed by a displacement of the web in a direction corresponding to a normal axis of the web.

15: The aircraft recited in claim 14, further comprising system cabling including cabling with large cross-sections disposed in a region underneath the stepped section of each web, and cabling with small cross-sections disposed in a vicinity of first and second web sections disposed on opposite sides of each stepped section.
